(19) United States
(12) Patent Application Publication
(10) Pub. No.: US 2026/0336468 A1
(43) Pub. Date: Oct. 29, 2026

(54) Method for Monitoring a State of Charge of a Battery of an Electric Work Vehicle

(71) Applicant: Caterpillar Inc., Peoria, IL (US)

(72) Inventor: Thomas L. TWIGGER, Spalding (GB)

(73) Assignee: Caterpillar Inc., Peoria, IL (US)

(21) Appl. No.: 18/997,440

(22) PCT Filed: Jul. 27, 2023
(86) PCT No.: PCT/US2023/071094

§ 371 Date: Jan. 21, 2025

(30) Foreign Application Priority Data
Aug. 5, 2022 (GB) 2211428.4

(51) Int. Cl. B60L 58/13; B60L 53/62; B60L 53/68; B60L 58/16

(52) U.S. Cl. CPC B60L 58/13; B60L 53/62; B60L 53/68; B60L 58/16; B60L 2200/40

(57) ABSTRACT

A method of monitoring a state of charge of a battery of an electric work vehicle comprises setting a first state of charge threshold and a second state of charge threshold. The first state of charge threshold is higher than zero and is selected from a first state of charge range. The second state of charge threshold is less than a highest charge capacity of the battery and is selected from a second state of charge range. In an event that an actual state of charge of the battery reaches the first state of charge threshold while the battery is discharging, a first notification is provided to an operator of the electric work vehicle. In an event that the battery is connected to a charging module, the battery is charged until an actual state of charge of the battery is equal to the second state of charge threshold.

### FIELD OF THE DISCLOSURE

The disclosure relates to the field of electric work vehicles.

### BACKGROUND

It is known that long-term battery health of re-chargeable batteries is affected by the manner in which they are charged and discharged. The speed of charging can affect battery health, as can the state of charge at which they are stored. Regularly discharging a battery to very low, or zero, state of charge may not be beneficial for long-term battery health. Similarly, leaving a battery for a period of time at 100% state of charge may not be beneficial for long-term battery health.

Some electric work vehicles provide low battery warnings at a fixed state of charge, in an effort to prevent an electric work vehicle running out of charge. A fixed low battery warning or charging the battery to 100% state of charge may not be universally appropriate, since work vehicles may have different usage patterns and operate in different environments. For example, the average distance of electric work vehicles from available chargers may vary. Similarly, the power consumption of the electric work vehicles may depend on the type of work they are carrying out. Furthermore, the amount of charge an electric work vehicle might be expected to use in a day, and therefore the state of charge required at the end of charging, may vary depending on the distance the vehicle is expected to travel or the type of work being carried out. Similarly, the amount of charge an electric work vehicle might need in reserve to travel to a charger might vary depending on the distance to the charger. The length of time that a battery might take to discharge from a given state of charge to a point at which it needs to travel to the charger may vary depending on the power consumption of the type of work being carried out.

### SUMMARY OF THE DISCLOSURE

Against this background, there is provided a method of monitoring a state of charge of a battery of an electric work vehicle. The method comprises setting a first state of charge threshold, wherein the first state of charge threshold is higher than zero and the first state of charge threshold is selected from a first state of charge range. The method further comprises setting a second state of charge threshold, wherein the second state of charge threshold is less than a highest charge capacity of the battery and the second state of charge is selected from a second state of charge range. In an event that an actual state of charge of the battery reaches the first state of charge threshold while the battery is discharging from an actual state of charge that is higher than the first state of charge threshold, the method further comprises providing a first notification to an operator of the electric work vehicle. In an event that the battery is connected to a charging module and an actual state of charge is lower than the second state of charge threshold, the method further comprises charging the battery until an actual state of charge of the battery is equal to the second state of charge threshold and maintaining the actual state of charge at the second state of charge threshold until the battery is disconnected from the charging module.

In this way, it is possible to provide a low battery warning at a particular state of charge that can be chosen (and changed) by an operator. The low battery warning can be tailored depending on battery health, as it can be beneficial to long term battery health to prevent a battery state of charge from falling too low. The low battery warning can also be tailored depending on usage patterns of the electric work vehicle and the environment of the electric work vehicle, for example the amount of charge an electric work vehicle might be expected to use in a shift or the distance an electric work vehicle might have to travel to a charging module. It is also possible to provide an upper charging limit that can be chosen (and changed) by an operator. The upper charging limit can be tailored depending on battery health, as it can be beneficial to long term battery health to prevent a state of charge of the battery from being too high (and, in particular, to prevent a battery from being stored at a high state of charge). The upper charging limit can also be tailored depending on usage patterns of the electric work vehicle and the environment of the electric work vehicle, for example the amount of charge an electric work vehicle might be expected to use in a shift.

There is also provided a device for monitoring a state of charge of a battery of an electric vehicle. The device comprises a controller configured to set a first state of charge threshold. The first state of charge threshold is higher than zero and the first state of charge threshold is selected from a first state of charge range. The controller is further configured to set a second state of charge threshold. The second state of charge threshold is less than a highest charge capacity of the battery and the second state of charge is selected from a second state of charge range. In an event that an actual state of charge of the battery reaches the first state of charge threshold while the battery is discharging from an actual state of charge that is higher than the first state of charge threshold, the controller is further configured to provide a first notification to an operator of the electric work vehicle. In an event that the battery is connected to a charging module and an actual state of charge is lower than the second state of charge threshold the controller is further configured to charge the battery until an actual state of charge of the battery is equal to the second state of charge threshold and maintain the actual state of charge at the second state of charge threshold until the battery is disconnected from the charging module.

### BRIEF DESCRIPTION OF THE DRAWINGS

A specific embodiment of the disclosure will now be described, by way of example only, with reference to the accompanying drawings in which:

FIG. 1 shows a schematic diagram of an electric work vehicle charging at a charging module.

FIG. 2 shows a flow diagram illustrating a method of monitoring a state of charge of a battery of an electric work vehicle in accordance with an embodiment of the present disclosure.

FIG. 3 shows a flow diagram illustrating a method of monitoring a state of charge of a battery of an electric work vehicle in accordance with an embodiment of the present disclosure.

FIG. 4 shows a flow diagram illustrating a method of monitoring a state of charge of a battery of an electric work vehicle in accordance with an embodiment of the present disclosure.

### DETAILED DESCRIPTION

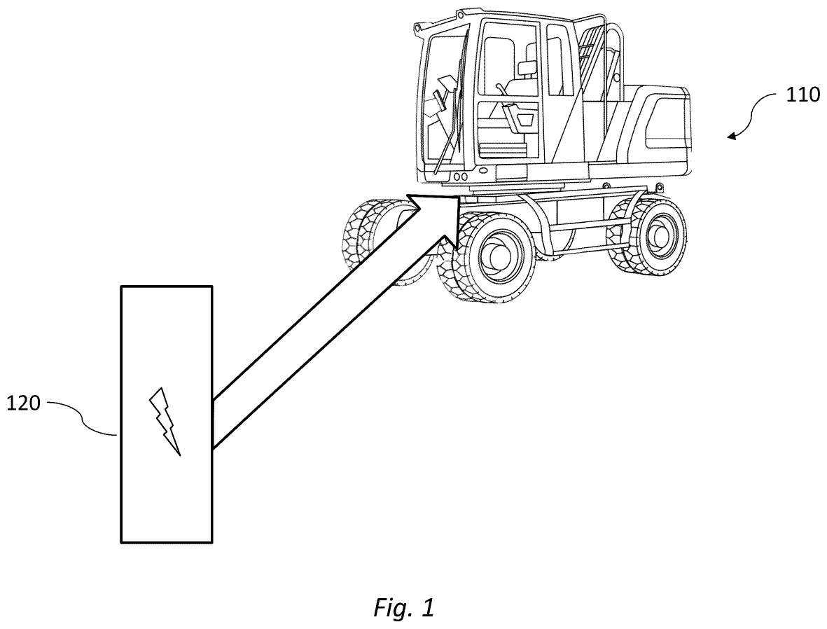

With reference to FIG. 1, an electric work vehicle 110 comprises a rechargeable battery. The battery may be connected to a charging module 120 for charging (indicated in FIG. 1 by an arrow). A controller may be configured to determine an actual state of charge of the battery. A controller may be configured to control charging of the battery while the electric work vehicle 110 is connected to the charging module 120. The specific electric work vehicle 110 in FIG. 1 is shown as an example. The electric work vehicle 110 may comprise any other type of electric work vehicle, and may be connected to a charging module 120 in any configuration.

A method of monitoring a state of charge of a battery of an electric work vehicle may comprise setting a low state of charge threshold (also referred to herein as a first state of charge threshold). In an event that the battery is discharging from a state of charge that is higher than the low state of charge threshold, a “low battery” warning may be issued in an event that an actual state of charge of the battery reaches the low state of charge threshold. The “low battery” warning may indicate that an actual state of charge of the battery has reached the low state of charge threshold. The “low battery” warning may comprise providing a first notification to an operator that an actual state of charge of the battery has reached the low state of charge threshold. The battery may be discharging when the electric work vehicle is in use (such as when the electric work vehicle is turned on, when it is being driven, or when a work tool of the electric work vehicle is being operated).

A method of monitoring a state of charge of a battery of an electric work vehicle may comprise setting a high state of charge threshold (also referred to herein as a second state of charge threshold). In an event that the battery is charging, the battery may be charged until an actual state of charge of the battery reaches the high state of charge threshold. The actual state of charge of the battery may then be maintained at the high state of charge threshold.

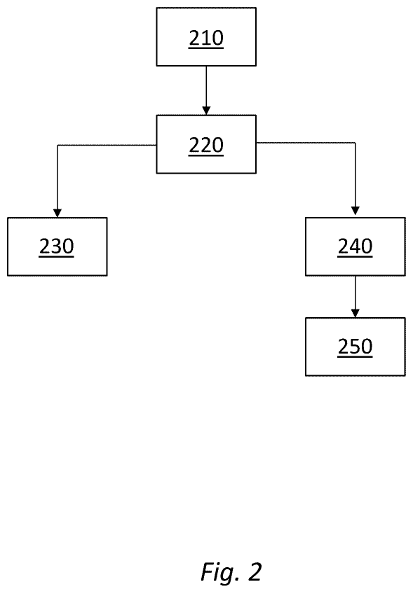

With reference to FIG. 2, a method of monitoring a state of charge of a battery of an electric work vehicle is illustrated. At step 210, a first state of charge threshold is set. The first state of charge threshold is higher than zero and is selected from a first state of charge range. At step 220, a second state of charge threshold is set. The second state of charge threshold is less than a highest charge capacity of the battery and is selected from a second state of charge range.

In an event that an actual state of charge of the battery reaches the first state of charge threshold while the battery is discharging from an actual state of charge that is higher than the first state of charge threshold, step 230 comprises providing a first notification to an operator of the electric work vehicle. In an event that battery is connected to a charging module and an actual state of charge is lower than the second state of charge threshold, the method comprises step 240 of charging the battery until an actual state of charge of the battery is equal to the second state of charge threshold, and step 250 of maintaining the actual state of charge at the second state of charge threshold until the battery is disconnected from the charging module.

Setting the first state of charge threshold may be done locally via an input device of the electric work vehicle. Setting the first state of charge threshold may be done remotely via remote communication. Setting the second state of charge threshold may be done locally via an input device of the electric work vehicle. Setting the second state of charge threshold may be done remotely via remote communication. Setting a threshold locally may comprise setting the threshold via an interface of the electric work vehicle. Setting a threshold locally may comprise setting the threshold for only that specific electric work vehicle. Setting a threshold remotely may comprise setting the threshold via a mobile device in the vicinity of the electric work vehicle (for example from outside the electric work vehicle or from somewhere on the worksite), or setting the threshold via a wireless connection (for example from somewhere on the worksite or from a remote server external to the worksite). Setting a threshold locally may comprise setting the threshold for only that specific electric work vehicle, or setting the threshold for multiple electric work vehicles.

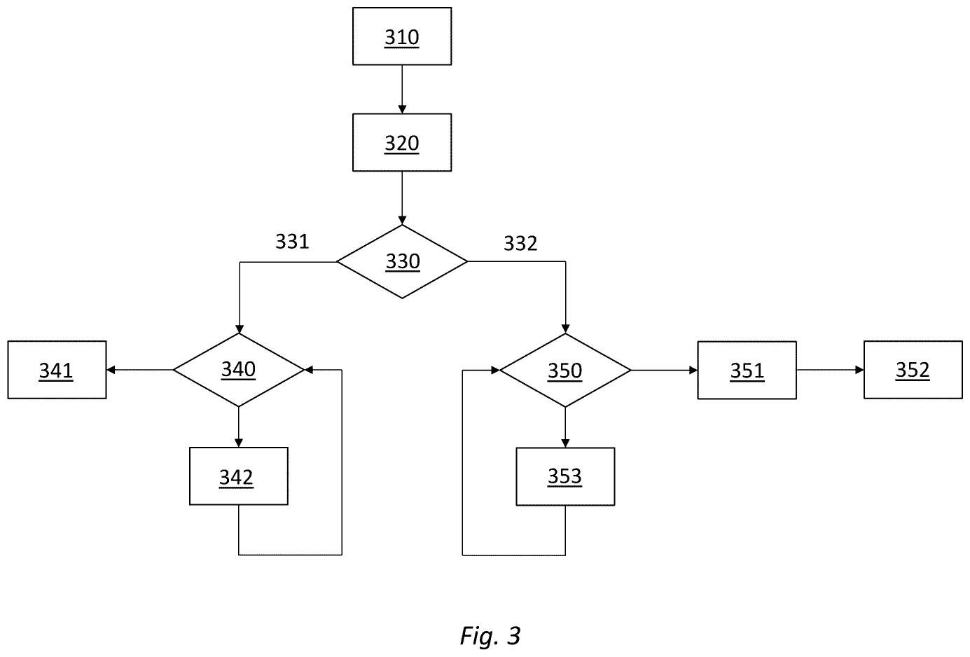

With reference to FIG. 3, a method of monitoring a state of charge of a battery of an electric work vehicle is illustrated in accordance with an embodiment of the present disclosure. At step 310, a first state of charge threshold may be set. The first state of charge threshold may be higher than zero and may be selected from a first state of charge range. Setting the first state of charge threshold may be done locally or remotely. At step 320, a second state of charge threshold may be set. The second state of charge threshold may be less than a highest charge capacity of the battery and may be selected from a second state of charge range. Setting the second state of charge threshold may be done locally or remotely.

The method of FIG. 3 may then follow one of two paths, depending on whether the battery is discharging or charging. At step 330, it may be determined whether the battery is discharging or charging (or connected to a charging module), with arrow 331 leading to the path for the battery discharging and arrow 332 leading to the path for the battery charging.

If the battery is discharging and the method follows 331, it may be determined whether an actual state of charge of the battery reaches the first state of charge threshold while the battery is discharging from an actual state of charge that is higher than the first state of charge threshold. At step 340 it may be determined whether actual state of charge of the battery is equal to the first state of charge threshold (wherein “equal to” is within a tolerance of the measurement). In an event that at step 340 an actual state of charge of the battery is equal to the first state of charge threshold, at step 341 a first notification may be provided to an operator of the electric vehicle. In an event that an actual state of charge of the battery does not reach the first state of charge threshold, at step 342 the method may return to step 340 and repeat step 340.

If the battery is charging or connected to a charging module and the method follows path 332, at step 350 it may be determined whether an actual state of charge of the battery reaches the second state of charge threshold while the battery is charging from an actual state of charge that is lower than the second state of charge threshold. At step 350 it may be determined whether actual state of charge of the battery is equal to the second state of charge threshold (wherein “equal to” is within a tolerance of the measurement). In an event that at step 350 an actual state of charge is less than the second state of charge threshold, at step 351 the battery may be charged until an actual state of charge of the battery is equal to the second state of charge threshold. At step 352 the actual state of charge of the battery may be maintained at the second state of charge threshold until the battery is disconnected from the charging module. In an event that at step 350 an actual state of charge of the battery is not equal to the second state of charge threshold, at step 353 the method may return to step 350 and repeat step 350.

In an embodiment, in an event that the battery is discharging and an actual state of charge of the battery reaches a first state of charge threshold and the battery continues discharging such that an actual state of charge of the battery subsequently reaches a first fraction of the first state of charge threshold, the methods described above may further comprise providing a second notification to the operator. The first fraction is less than one. The first fraction of the first state of charge threshold may be selected by the user, or may be selected automatically. The first fraction of the first state of charge threshold may be selected as a fraction or percentage, or as a state of charge value. This stage may be repeated for further fractions of the first state of charge threshold, wherein the further fractions decrease and further notifications are provided to the operator.

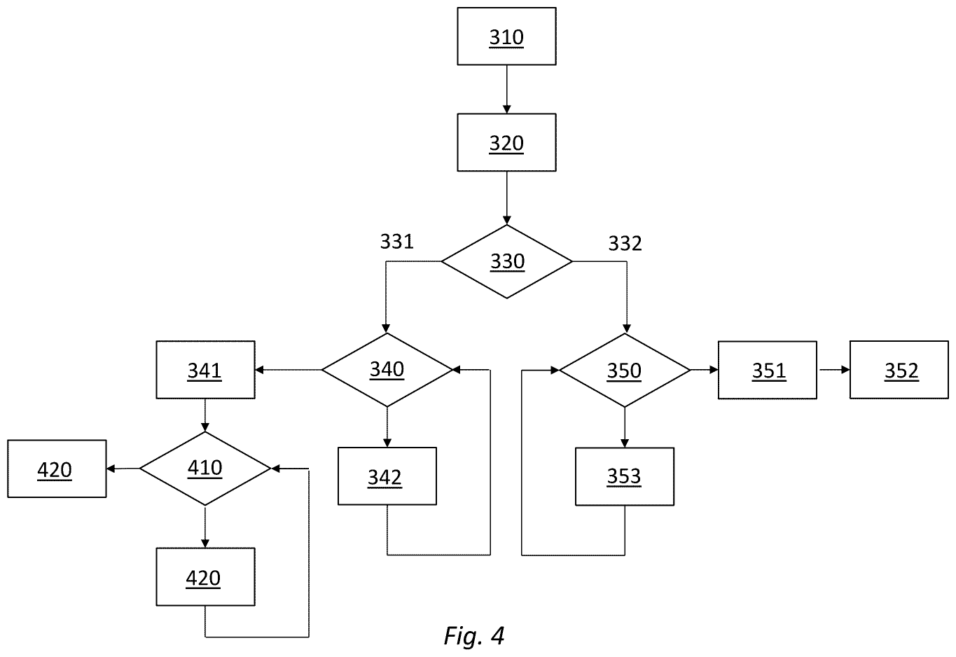

The extra stage of notifying the user when the actual state of charge of the battery subsequently reaches a first fraction of the first state of charge threshold may be applied to the methods of FIG. 2 or FIG. 3, but as an illustrative example FIG. 4 shows the method of FIG. 3 with this extra stage. The steps of the method of FIG. 3 retain the reference numerals. After step 340 and 341 of determining that an actual state of charge of the battery is equal to the first state of charge threshold and providing a first notification to the operator, the method may further comprise determining whether the battery continues such that an actual state of charge of the battery subsequently reaches a first fraction of the first state of charge threshold. At step 410, it may be determined whether an actual state of charge of the battery is equal to the first fraction of the first state of charge threshold. In an event that at step 410 an actual state of charge of the battery is equal to a first fraction of the first state of charge threshold, at step 420 a second notification may be provided to the operator of the electric vehicle. In an event that an actual state of charge of the battery does not reach the first fraction of the first state of charge threshold, at step 430 the method may return to step 410 and repeat step 410.

In an embodiment, one or both of the first state of charge threshold and the second state of charge threshold may be set via a user input device. The electric work vehicle may comprise the user input device, for example as a display screen and/or input keys. The user input device may comprise a mobile electronic device. The user input device may comprise a remote device.

In an embodiment, an operator of the electric work vehicle may set one or both of the first state of charge threshold and the second state of charge threshold. In an embodiment, a remote user may set one or both of the first state of charge threshold and the second state of charge threshold. For example, a site manager or an off-site user may set one or both of the first state of charge threshold and the second state of charge threshold.

In an embodiment, the first state of charge threshold may be selected from a pre-determined list of first state of charge thresholds. The second state of charge threshold may be selected from a pre-determined list of second state of charge thresholds. In an embodiment, the first state of charge threshold may be any value within the first state of charge range and/or the second state of charge threshold may be any value within the second state of charge range. For example, an operator may be able to input any number within the first state of charge range and/or second state of charge range, respectively.

In an embodiment, the first state of charge range may be based on data indicative of prior usage of the battery. The second state of charge range may be based on data indicative of prior usage of the battery. For example, the data indicative of prior usage of the battery may comprise one or more of the number of charge cycles; the length of time providing power to the electric work vehicle or total amount of charge provided; charging characteristics such as speed of charging or the state of charge range; a distribution of state of charge reached when charging or in use; temperature of the battery; age of the battery; length of work time available on a full charge of the battery (or rate of discharge in use); or other characteristics. The data indicative of prior usage of the battery may be used to infer battery health, and in an event that the battery health is deemed to be deteriorating, the first state of charge range may be raised and/or the second state of charge range may be lowered. The data indicative of prior usage of the battery may be used in combination with known characteristics, for example a lookup table corresponding number of charge cycles (or any other parameter) to likely battery health or to the suggested first and second state of charge ranges. The data indicative of prior usage of the battery may be used in combination with data from other batteries, for example to correspond the number of charge cycles (or any other parameter) of the battery to the likely battery health based on data from other batteries.

In an embodiment, the first state of charge range may be based on data indicative of battery health. The second state of charge range may be based on data indicative of battery health. Battery health may include the capability of a battery to receive charge, and may deteriorate over time. Symptoms of deterioration of battery health may be a lowering of the total capacity of the battery to store charge, and/or a reduction in the speed at which the battery can take on charge. In an event that the battery health is deemed to be deteriorating, the first state of charge range may be raised and/or the second state of charge range may be lowered.

Basing the first state of charge range and/or the second state of charge range on data indicative of prior usage of the battery or on battery health may be done by a user or automatically (for example based on certain thresholds of use, or based on machine learning).

The first state of charge threshold or first state of charge range may be based on characteristics of the user, usage patterns of the electric work vehicle or the environment of the work site. For example, the first state of charge threshold may be based on the amount of charge an electric work vehicle might be expected to use in a shift or the distance an electric work vehicle might have to travel to a charging module. For example, if a work site is small or has a relatively high density of charging modules, the electric work vehicle may need a relatively low state of charge to travel to a charging module so the first state of charge threshold may be relatively low. Conversely, if a work site is large or has a relatively low density of charging modules, the electric work vehicle may need a relatively high state of charge to travel to a charging module so the first state of charge threshold may be relatively high. If a user is carrying out low-power work (such that the rate of discharge of the battery is relatively low), a given state of charge will last longer than if the work is high-power so the first state of charge threshold may be relatively low. The second state of charge threshold may be based on characteristics of the user, usage patterns of the electric work vehicle or the environment of the work site. For example, the second state of charge threshold may be based on the amount of charge an electric work vehicle might be expected to use in a shift.

The first notification (and/or second notification in certain embodiments) may comprise any form of notification. For example, the notification may comprise a light, a sound, a message on an in-cab device, a message on a mobile device, or other notification.

In an event that when an electric vehicle begins discharging or is turned on an actual state of charge is below the first state of charge threshold, the method may comprise notifying the operator. In an event that when an electric vehicle begins charging or is connected to a charging module and an actual state of charge is above the second state of charge threshold, the method may comprise maintaining the actual state of charge at that state of charge or the method may comprise discharging the battery such that an actual state of charge is equal to the second state of charge threshold and then maintaining the actual state of charge at the second state of charge threshold.

In an embodiment, a device for monitoring a state of charge of a battery of an electric vehicle comprises a controller. The controller is configured to set a first state of charge threshold. The first state of charge threshold is higher than zero. The first state of charge threshold is selected from a first state of charge range. The controller is further configured to set a second state of charge threshold. The second state of charge threshold is less than a highest charge capacity of the battery. The second state of charge is selected from a second state of charge range. In an event that an actual state of charge of the battery reaches the first state of charge threshold while the battery is discharging from an actual state of charge that is higher than the first state of charge threshold, the controller is further configured to notify an operator of the electric work vehicle. In an event that the battery is connected to a charging module and an actual state of charge is lower than the second state of charge threshold, the controller is further configured to charge the battery until an actual state of charge of the battery is equal to the second state of charge threshold and maintain the actual state of charge at the second state of charge threshold until the battery is disconnected from the charging module.

The device may be configured to carry out any of the methods described above.

1. A method of monitoring a state of charge of a battery (120) of an electric work vehicle (110), the method comprising:
setting a first state of charge threshold (210), wherein:
the first state of charge threshold is higher than zero; and
the first state of charge threshold is selected from a first state of charge range;
setting a second state of charge threshold (220), wherein:
the second state of charge threshold is less than a highest charge capacity of the battery; and
the second state of charge is selected from a second state of charge range;
in an event that an actual state of charge of the battery reaches the first state of charge threshold while the battery is discharging from an actual state of charge that is higher than the first state of charge threshold, providing a first notification to an operator of the electric work vehicle (230); and
in an event that the battery is connected to a charging module and an actual state of charge is lower than the second state of charge threshold:
charging the battery until an actual state of charge of the battery is equal to the second state of charge threshold (240); and
maintaining the actual state of charge at the second state of charge threshold until the battery is disconnected from the charging module (250).

2. The method of any preceding claim wherein one or both of the first state of charge threshold and the second state of charge threshold is set via a user input device.

3. The method of claim 1 wherein setting the first state of charge threshold is done via an input device of the electric work vehicle.

4. The method of claim 1 wherein setting the first state of charge threshold is done via remote communication.

5. The method of any of claims 1 to 3 wherein setting the second state of charge threshold is done via an input device of the electric work vehicle.

6. The method of any of claims 1 to 3 wherein setting the second state of charge threshold is done via remote communication.

7. The method of any preceding claim wherein in an event that the actual state of charge of the battery reaches a first state of charge threshold while the battery is discharging and the actual state of charge of the battery subsequently reaches a first fraction of the first state of charge threshold and wherein the first fraction is less than one, the method further comprises providing a second notification to an operator.

8. The method of claim 4 or 5 wherein the electric work vehicle comprises the user input device.

9. The method of any preceding claim wherein the user input device comprises a mobile electronic device.

10. The method of any preceding claim wherein the operator of the electric work vehicle sets one or both of the first state of charge threshold and the second state of charge threshold.

11. The method of any preceding claim wherein the first state of charge threshold is selected from a pre-determined list of first state of charge thresholds.

12. The method of any of any preceding claim wherein the second state of charge threshold is selected from a pre-determined list of second state of charge thresholds.

13. The method of any preceding claim wherein the first state of charge range is based on data indicative of prior usage of the battery.

14. The method of any preceding claim wherein the second state of charge range is based on data indicative of prior usage of the battery.

15. A device for monitoring a state of charge of a battery (120) of an electric vehicle (110), wherein the device comprises a controller configured to:
set a first state of charge threshold, wherein:
the first state of charge threshold is higher than zero;
the first state of charge threshold is selected from a first state of charge range; and
set a second state of charge threshold, wherein:
the second state of charge threshold is less than a highest charge capacity of the battery;
the second state of charge is selected from a second state of charge range; and
in an event that an actual state of charge of the battery reaches the first state of charge threshold while the battery is discharging from an actual state of charge that is higher than the first state of charge threshold, provide a first notification to an operator of the electric work vehicle; and
in an event that the battery is connected to a charging module and an actual state of charge is lower than the second state of charge threshold:
charge the battery until an actual state of charge of the battery is equal to the second state of charge threshold; and
maintain the actual state of charge at the second state of charge threshold until the battery is disconnected from the charging module.

16. The device for monitoring the state of charge of the battery (120) of the electric vehicle (110) of claim 15, further comprising at least one of:
a user input device for a user to input one or both of the first state of charge threshold and the second state of charge threshold;
an input device on the electric work vehicle for selecting locally one or both of the first state of charge threshold and the second state of charge threshold; and
a remote communication receiver for setting one or both of the first state of charge threshold and the second state of charge threshold in response to a remote communication.
